(19) United States
(12) Patent Application Publication
(10) Pub. No.: US 2025/0320779 A1
(43) Pub. Date: Oct. 16, 2025

(54) DUAL-PURPOSE FOLDING LADDER

(71) Applicant: HIEVER CO., LTD., Taichung City (TW)

(72) Inventors: Tony Huang, Taichung City (TW); Jeffery HUANG, Taichung City (TW)

(73) Assignee: HIEVER CO., LTD., Taichung City (TW)

(21) Appl. No.: 18/745,161

(22) Filed: Jun. 17, 2024

(30) Foreign Application Priority Data
Apr. 16, 2024 (TW) 113203751

(51) Int. Cl. E06C 1/393; B25H 5/00; E06C 1/397; E06C 7/02

(52) U.S. Cl. CPC E06C 1/393; B25H 5/00; E06C 1/397; E06C 7/02

(57) ABSTRACT

A dual-purpose folding ladder includes: a base including a plurality of casters provided under the base, a positioning mount provided on the base, and two supporting rods provided on one side of the base; two guide rails each pivotally provided at, and rotatable with respect to, a corresponding one of the two supporting rods, with a connecting plate provided between the two guide rails; a supporting post pivotally connected to the connecting plate at one end and connected to the positioning mount at the other end; two supporting arms each mounted in a corresponding one of the two guide rails, with a plurality of rungs provided between and connecting the two supporting arms; two extension arms each provided at one end of a corresponding one of the supporting arms; and a first pad pivotally provided on the two supporting arms and provided with an arc-shaped positioning plate on one side.

### BACKGROUND OF THE INVENTION

### 1. Technical Field

The present invention relates to a ladder that is foldable and easy to use. More particularly, the invention relates to a dual-purpose folding ladder.

### 2. Description of Related Art

To perform maintenance work on a vehicle of a relatively great height, a ladder is generally required as an auxiliary tool. For example, when servicing the engine of a truck, a ladder is used so that a maintenance worker can have a sufficient height for carrying out the intended maintenance operations. When not in use, however, such a ladder, typically a folding ladder, can only be folded and put aside, meaning the ladder not only takes up space, but also serves no other function while not in use.

### BRIEF SUMMARY OF THE INVENTION

The primary objective of the present invention is to provide a dual-purpose folding ladder that can serve either as a ladder or a reclining chair (or creeper).

To achieve the primary objective, the dual-purpose folding ladder of the present invention includes a base, a two guide rails, a supporting post, two supporting arms, two extension arms, and a first pad. The base is provided with a plurality of casters under the base. The base is provided with a positioning mount and is provided with two supporting rods on one side. Each of the two guide rails is pivotally provided at, and can be rotated with respect to, a corresponding one of the two supporting rods. Each guide rail is provided with a positioning hole, and a connecting plate is provided between the two guide rails. The supporting post is pivotally connected to the connecting plate at one end and is connected to the positioning mount of the base at the other end. Each of the two supporting arms is mounted in, and can be moved in an axial direction with respect to, a corresponding one of the two guide rails. Each of the two supporting arms is provided with a plurality of positioning holes, and a plurality of rungs are provided between the two supporting arms to connect the two supporting arms. Each of the two extension arms is provided at one end of a corresponding one of the supporting arms. The first pad is pivotally provided on the two supporting arms and is provided with an arc-shaped positioning plate on one side. The arc-shaped positioning plate is provided with a plurality of positioning holes, and the first pad can be adjusted in angle and fixed in position by inserting a pin selectively through one of the positioning holes of the arc-shaped positioning plate and one of the positioning holes of the corresponding extension arm.

The foregoing structures are such that the dual-purpose folding ladder of the present invention can be converted from a ladder into a creeper, and thus achieve the objective of the invention, by laying down the two guide rails and adjusting the angle of the first pad.

### BRIEF DESCRIPTION OF THE SEVERAL VIEWS OF THE DRAWINGS

FIG. 1 is a perspective view of the present invention.

FIG. 2 is another perspective view of the present invention, with the viewing angle different from that of FIG. 1.

FIG. 3 is a side view of the present invention, showing the supporting post in a different supporting position from that in FIG. 1 and FIG. 2.

FIG. 4 is another side view of the present invention.

FIG. 5 is a partial perspective view of the present invention, showing the first pad in an upwardly inclined state.

FIG. 6 is a sectional view taken along line 6-6 in FIG. 5.

FIG. 7 is a perspective view of the present invention, showing the invention in a folded state and serving as a creeper.

FIG. 8 is a partial perspective view of the present invention, showing each of the two supporting arms mounted in a corresponding one of the two guide rails and secured in position by a pin.

FIG. 9 is a perspective view of the present invention with the safe bord.

FIG. 10 is a side view of the present invention with the safe bord.

### DETAILED DESCRIPTION OF THE INVENTION

To start with, the applicant wishes to point out that throughout this specification, which includes the following description of an embodiment and the appended claims, all the direction-related terms such as upward, downward, left, and right make reference to the directions in the accompanying drawings and are used only to facilitate description but not to be limiting. In addition, the same reference numeral in the following description of the embodiment and in the drawings indicates identical or similar elements or structural features.

Referring to all the drawings, the dual-purpose folding ladder of the present invention includes a base 10, two guide rails 20, a supporting post 30, two supporting arms 40, two extension arms 50, and a first pad 60.

The base 10 is composed of a longitudinal bar 101 and two transverse bars 102. Each of the two transverse bars 102 is provided at one of the two ends of the longitudinal bar 101, and a plurality of casters 11 are provided under each of the two transverse bars 102. The longitudinal bar 101 is provided with at least one positioning mount 12 and is shown in the drawings of this embodiment as having two positioning mounts 12 by way of example. The number of the at least one positioning mount 12, however, is not limited to two. One side of the base 10 is provided with two supporting rods 13. The supporting rods 13 extend upward from the base 10 and are tilted at a predetermined angle. In this embodiment, the two supporting rods 13 are provided on one of the two transverse bars 102, and the other transverse bar 102 is provided with two positioning stop blocks 14. Each positioning stop block 14 is provided with a positioning hole 15.

Each of the two guide rails 20 has one end pivotally provided at, and can therefore be rotated with respect to, a corresponding one of the two supporting rods 13. Each guide rail 20 is provided with a positioning hole 21. A connecting plate 22 is provided between the two guide rails 20.

The supporting post 30 has one end pivotally connected to the connecting plate 22 and the other end connected to the desired one of the positioning mounts 12. In this embodiment, the supporting post 30 and either of the positioning mounts 12 are designed to be fixed together with a pin, although a mortise and tenon, a screw, or other positioning methods may be used instead; the present invention has no limitation in this regard.

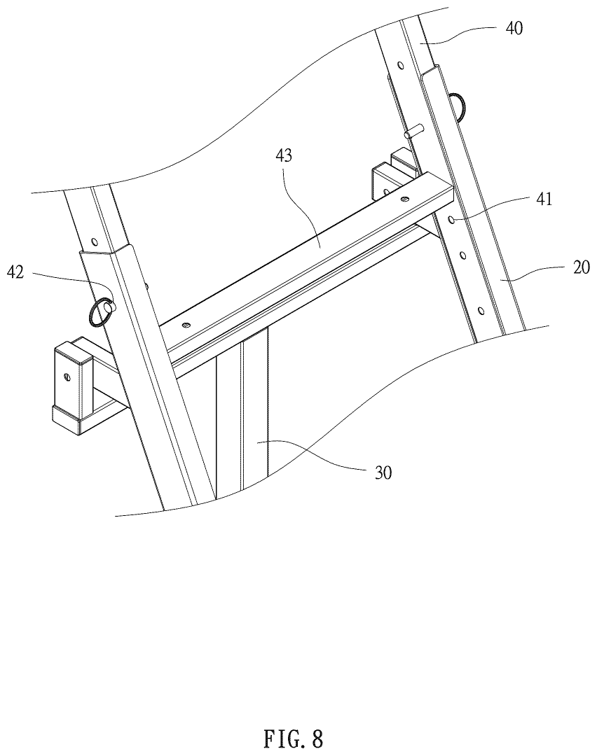

Each of the two supporting arms 40 is mounted in, and can be moved in an axial direction with respect to, a corresponding one of the two guide rails 20. Each of the two supporting arms 40 is provided with a plurality of positioning holes 41 and is secured in position to the positioning hole 21 of the corresponding one of the two guide rails 20 by a pin 42, as shown in FIG. 8. A plurality of rungs 43 are provided between the two supporting arms 40 to connect the two supporting arms 40 such that the two supporting arms 40 and the rungs 43 form a ladder.

Each of the two extension arms 50 is provided at one end of a corresponding one of the supporting arms 40 such that each extension arm 50 and the corresponding supporting arm 40 form an angle greater than 90 degrees and less than 180 degrees. Each extension arm 50 is provided with a plurality of positioning holes 51.

The first pad 60 is provided with two pivotal connection rods 61. The first pad 60 is pivotally connected to the two supporting arms 40 through the two pivotal connection rods 61. Each pivotal connection rod 61 is provided with an arc-shaped positioning plate 62 on one side, and each arc-shaped positioning plate 62 is provided with a plurality of positioning holes 63. The first pad 60 can be adjusted in angle and secured in position by inserting a pin 64 selectively through one of the positioning holes 63 of each arc-shaped positioning plate 62 and one of the positioning holes 51 of the corresponding extension arm 50.

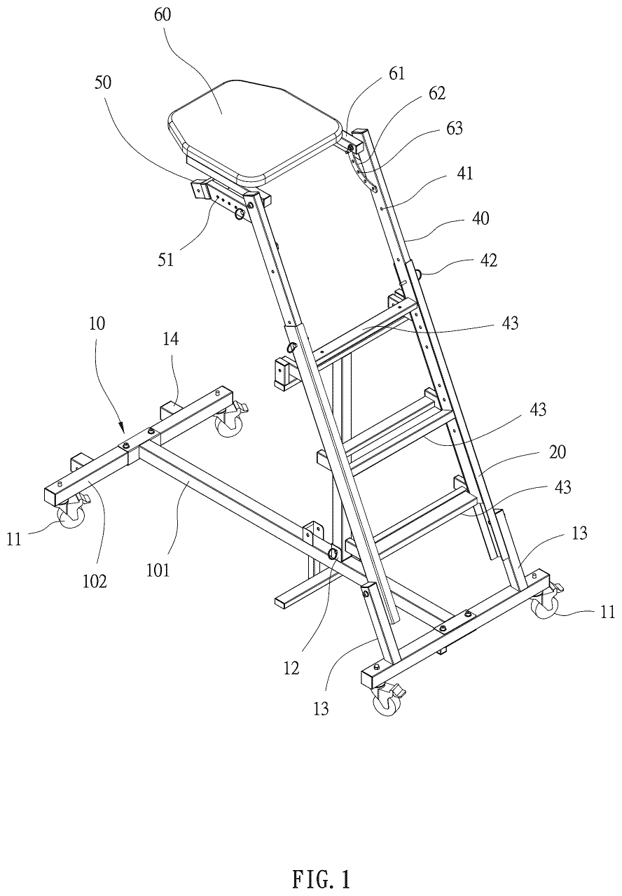

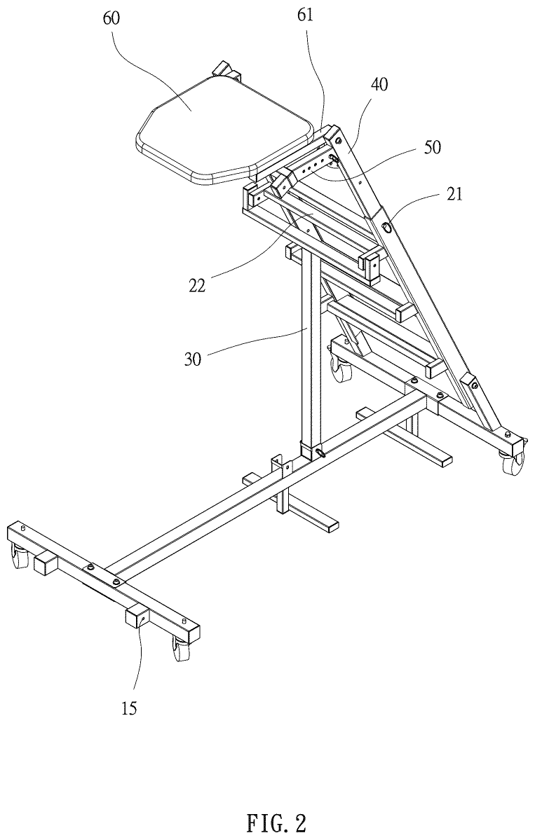

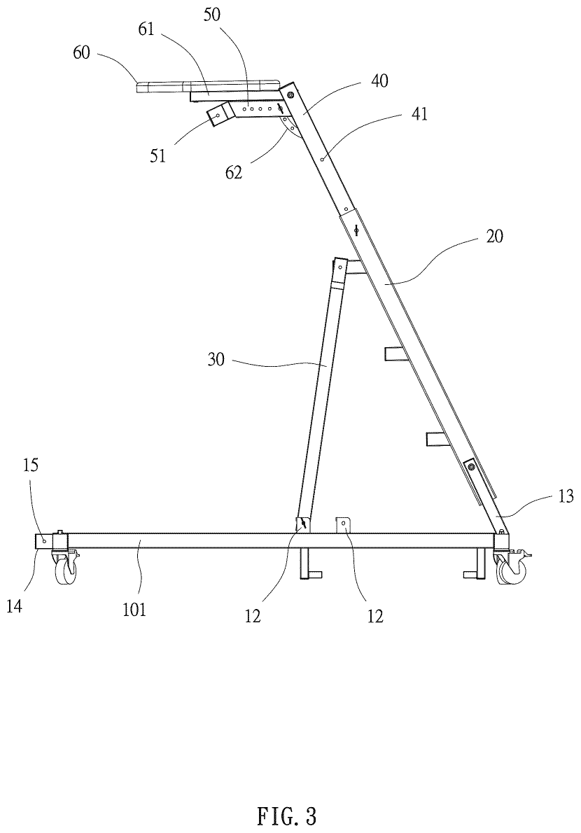

The foregoing structures are such that when the present invention is used as a ladder as shown in FIG. 1 to FIG. 3, the ladder made up of the two supporting arms 40 and the rungs 43 extends in the direction of the two guide rails 20. The two guide rails 20 are supported on the base 10 by the supporting post 30 and the two supporting rods 13, and the tilt angle of the two guide rails 20 can be changed by adjusting the position of the supporting post 30. Moreover, to use the invention as a ladder, the first pad 60 is rotated to be parallel to the longitudinal bar 101 of the base 10 so that a maintenance worker can lean their upper body against the first pad 60 as needed to make it easier to perform the maintenance work.

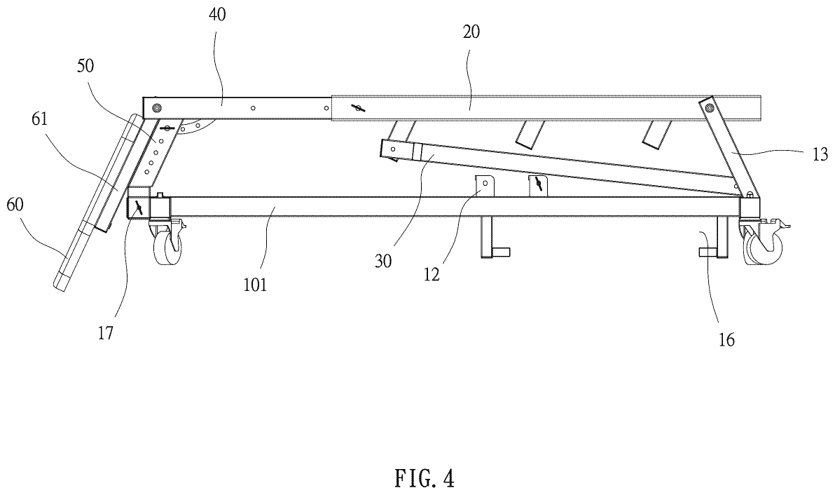

To fold the ladder into a creeper, the first step is to remove the supporting coupling between the supporting post 30 and the positioning mount 12 in use, so that the two guide rails 20 can be rotated to bring the positioning holes 51 of the extension arms 50 close to the positioning holes 15 of the positioning stop blocks 14 of the base 10. After that, a pin 17 is inserted through one of the positioning holes 51 of each extension arm 50 and the positioning hole 15 of the corresponding positioning stop block 14 to secure the guide rails 20 in place, with the supporting post 30 lying one the base 10, as shown in FIG. 4. Thus, the ladder formed of the two supporting arms 40 and the rungs 43 is converted into the main supporting section of a creeper.

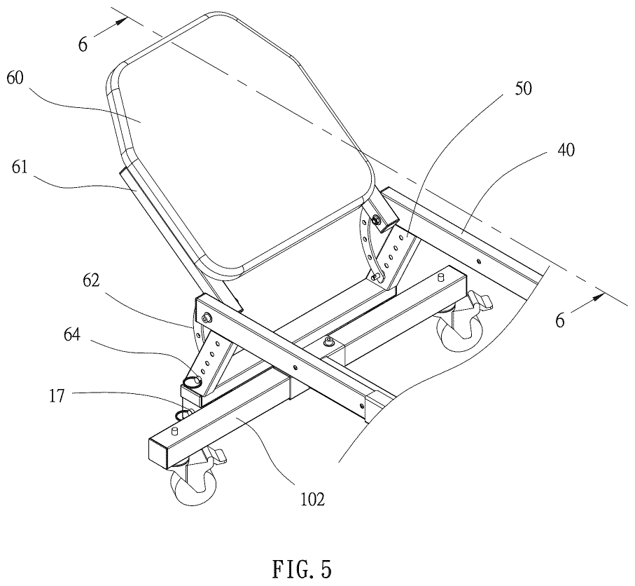

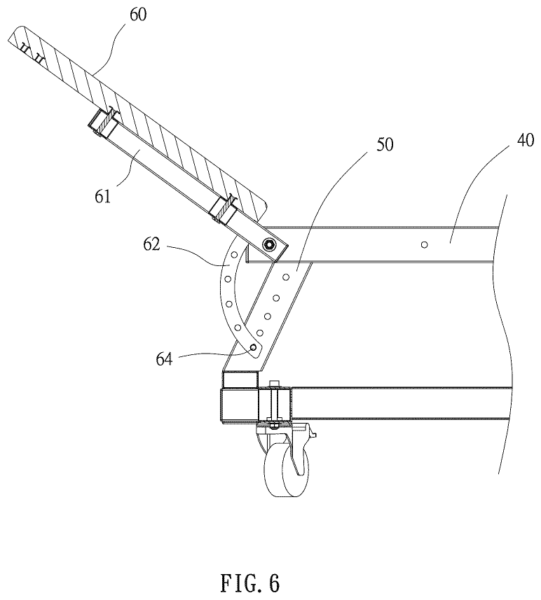

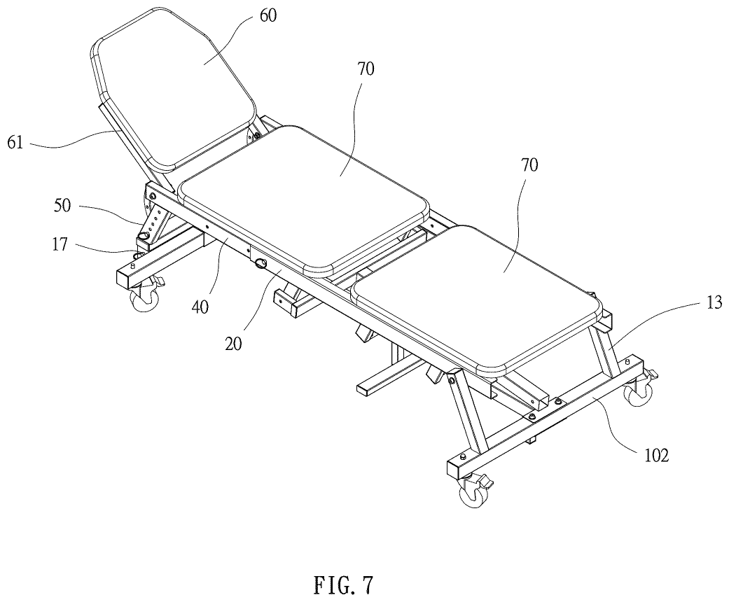

The first pad 60 is then rotated upward as shown in FIG. 5 and FIG. 6, and the last step is to place two pads 70 on the aforesaid main supporting section to complete the conversion into a creeper, as shown in FIG. 7.

To facilitate storage of the pads 70, a pad storage area 16 may be provided under the base 10 as shown in FIG. 1 and FIG. 4. The pad storage area 16 is composed of two downwardly extending L-shaped frames so that the two pads 70 can be placed on and between the two L-shaped frames. It should be additionally pointed out that when the two guide rails 20 are laid down to form a creeper, the two extension arms 50 are not necessarily fixed to the positioning stop blocks 14 of the base 10; the two extension arms 50 may rest directly on the base 10 instead. For example, the extension arms 50 can be rested directly on one transverse bar 102 of the base 10 when the guide rails 20 and the supporting arms 40 are laid down to form a creeper.

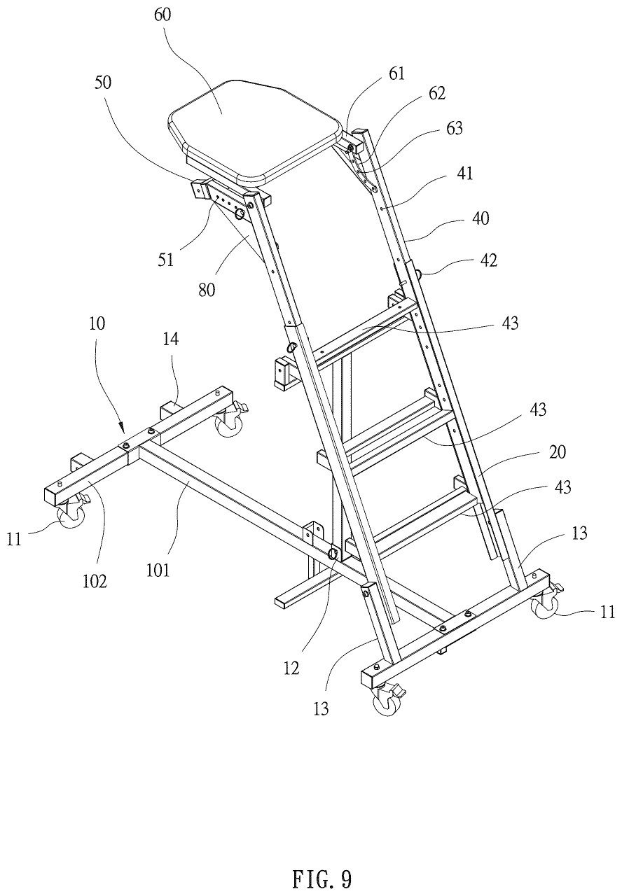

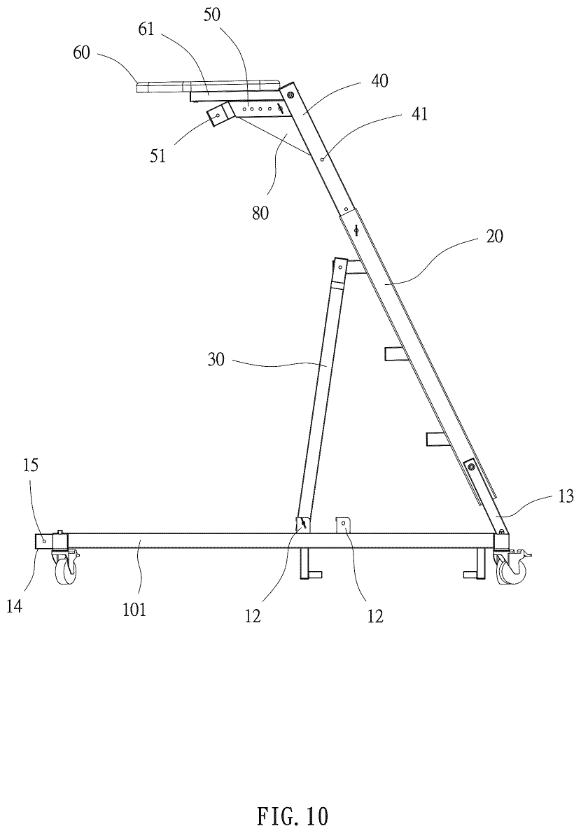

In addition, in order to increase the safety when using, the invention add a safe bord 80 between the extension arm 50 and the supporting arm 40 as shown in FIG. 9 and FIG. 10. these two safe bords 80 prevent users from being pinched by the arc-shaped positioning plate 62 when the first pad 60 folds back and near to the extension arm 50.

What is claimed is:

1. A dual-purpose folding ladder, comprising:
a base with a plurality of casters provided under the base, wherein the base is provided with a positioning mount and has a side provided with two supporting rods;
two guide rails each pivotally provided at, and rotatable with respect to, a corresponding one of the two supporting rods, wherein each said guide rail is provided with a positioning hole, and a connecting plate is provided between the two guide rails;
a supporting post having an end pivotally connected to the connecting plate and an opposite end connected to the positioning mount of the base;
two supporting arms each mounted in, and movable in an axial direction with respect to, a corresponding one of the two guide rails, wherein each of the two supporting arms is provided with a plurality of positioning holes and is secured in position to the positioning hole of the corresponding one of the two guide rails by a pin, and a plurality of rungs are provided between the two supporting arms to connect the two supporting arms such that the two supporting arms and the rungs form a ladder;
two extension arms each provided at an end of a corresponding one of the supporting arms such that each said extension arm and the corresponding one of the supporting arms form an angle greater than 90 degrees and less than 180 degrees; and
a first pad pivotally connected to the two supporting arms, wherein the first pad has a side provided with an arc-shaped positioning plate, the arc-shaped positioning plate is provided with a plurality of positioning holes, and the first pad is able to be adjusted in angle and secured in position by inserting a pin selectively through a said positioning hole of the arc-shaped positioning plate and a said positioning hole of a corresponding one of the extension arms.

2. The dual-purpose folding ladder of claim 1, wherein the first pad is provided with two pivotal connection rods, the first pad is pivotally connected to the two supporting arms through the two pivotal connection rods, and each said pivotal connection rod has a side provided with a said arc-shaped positioning plate.

3. The dual-purpose folding ladder of claim 1, wherein the base is composed of a longitudinal bar and two transverse bas, and each of the two transverse bars is provided at one of two ends of the longitudinal bar.

4. The dual-purpose folding ladder of claim 3, wherein the positioning mount is provided on the longitudinal bar.

5. The dual-purpose folding ladder of claim 3, wherein one of the two transverse bars is provided with two positioning stop blocks, and each said positioning stop block is provided with a positioning hole.

6. The dual-purpose folding ladder of claim 5, wherein the supporting rods are provided on a said transverse bar different from the transverse bar provided with the positioning stop blocks.

7. The dual-purpose folding ladder of claim 6, wherein the positioning holes of the extension arms are able to be brought close to the positioning holes of the positioning stop blocks so that a pin is able to be inserted through a said positioning hole of each said extension arm and the positioning hole of a corresponding one of the positioning stop blocks to produce a positioning effect.

8. The dual-purpose folding ladder of claim 1, wherein the ladder formed of the two supporting arms and the rungs is convertible into a main supporting section of a creeper.

9. The dual-purpose folding ladder of claim 8, wherein the main supporting section is able to be provided thereon with two pads.

10. The dual-purpose folding ladder of claim 9, wherein the base is provided thereunder with a pad storage area.
